(19) United States
(12) Patent Application Publication
(10) Pub. No.: US 2007/0014114 A1
(43) Pub. Date: Jan. 18, 2007

(54) Illumination system for videoprojector utilizing a plurality of dmd devices

(75) Inventor: Giorgio Barazza, Pardenone (IT)

Correspondence Address: LEVINE & MANDELBAUM, 444 MADISON AVENUE, 35TH FLOOR, NEW YORK, NY, 10022, US

(73) Assignee: SIM2 MULTIMEDIA S.P.A., Pardenone (IT)

(21) Appl. No.: 10/570,886

(22) PCT Filed: Aug. 26, 2004
(86) PCT No.: PCT/IB04/02757

§ 371 Date: Mar. 9, 2006

(30) Foreign Application Priority Data
Sep. 5, 2003 (IT) TO2003 A 000676

(51) Int. Cl. F21V 7/00

(52) U.S. Cl. 362/297

(57) ABSTRACT

An illumination system for videoprojectors has a light beam, a device for decomposing the light beam into a plurality of monochromatic components, a plurality of DMD devices each of which reflects one of the monochromatic components, and a plurality of devices adapted to send the monochromatic components towards the plurality of DMD devices. A second device separate from the first device recomposes the monochromatic components coming from the DMD devices into a light beam to be sent to a projection lens.

The present invention refers to an illumination system for videoprojectors utilizing a plurality of DMD (Digital Micromirror Device) devices. In the following description the abbreviation DMD will always be used to indicate these devices, the English name being Digital Micromirror Device.

Briefly a DMD device, or panel, comprises of a set of small squared mirrors, typically in aluminium, with a side of approximately 14 μm, each mirror forming an element of the image to be projected, in brief a pixel. The mirrors can rotate around a diagonal of a certain angle, for example ±12 degrees, and the rotation in either direction is produced by two electrodes located under the mirror on opposite sides with respect to the rotation axis.

The light strikes the mirror with an angle of approximately 26 degrees with respect to the perpendicular of the mirror surface, when this is in a “rest” position, that is when the mirror is not attracted by neither two electrodes. If the mirror is rotated in one direction, the light that strikes it is reflected in such a way that it does enter the project lens and therefore is not sent to the screen, and the pixel is then “off”; if the rotation takes place in the opposite direction the pixel is “on”, as the reflected light is sent to the screen.

In the more economical projectors a single DMD device is used and in this case the mirrors of said DMD device are illuminated in succession by the three primary colours red, green and blue, obtained by sending the light of an illuminating lamp to a rotating wheel, also know as colour wheel.

Said colour wheel is divided into three sectors, each of which comprises a dichroic filter correspondent to one of the three primary colours red, green and blue; said dichroic filters, in fact, are made of a multiple layers, which can have a low or high refraction index and, based on the type and the number of the layers of the dichroic filter, it can assume a basic coloration, which can be red, green, blue, etc.

Moreover these dichroic filters have very particular characteristics, as they work on a principle of interference, that is essentially separating two colours from a white light source, one of these colours being transmitted and the other, complementary to the first, being reflected.

So the rotation of the colour wheel equipped with dichroic filters, each corresponding to one of the three primary colours, permits the path of the light emitted by the illuminating lamp to be blocked by a different type of dichroic filter, according to the position of said colour wheel; this allows the light beam transmitted by the dichroic filter to assume in sequence the colouring corresponding to one of the three principal monochromatic components, such as red, green and blue.

Said monochromatic components are then sent to the DMD device.

When a very high degree of brightness is required, for example to illuminate large screens, an increased number of DMD devices are used in the projector, usually three; in this case the light of a lamp is divided into the three monochromatic components red, green and blue by a prism, and each of said monochromatic components is sent to a different DMD device.

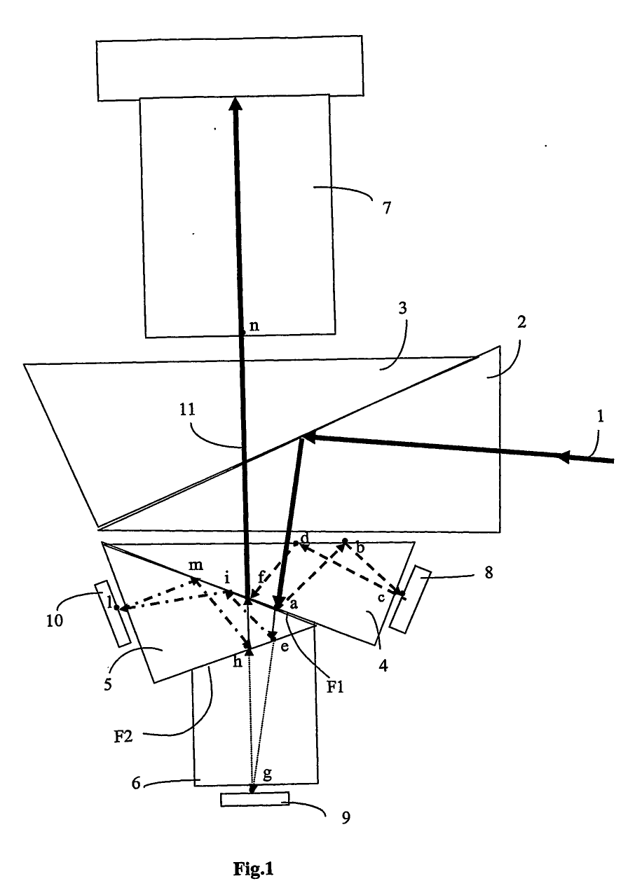

FIG. 1 shows an outline sketch of a known illumination system which uses three DMD devices; for simplicity, only the part which regards the light decomposition in the three primary monochromatic components (red, green and blue) is represented; the subsequent illumination of the three DMD devices and the recomposition of the monochromatic components in a single light beam.

The continuous line indicated by the reference number 1 represents a white light beam, made homogeneous and focused by known procedures and so not indicated in the figure.

The prism 2 is of the known type TIR (Total Internal Reflection and with this abbreviation it will be always referred to in the following description) and operates in total reflection due to the presence of a layer of air which separates it from a second prism to which it is associated, indicated with number 3.

The white light beam 1 is then reflected by the TIR prism 2 towards the prism 4; the dichroic surface which separates the prism 4 from the prism 5 constitutes a first dichroic filter F1 which, for example, transmits the green and blue monochromatic components of the white light beam 1 and reflects the red monochromatic component. The latter therefore, following the path indicated by the broken lines and by the arrows, first illuminates a DMD device 8 following the path a-b-c and it is reflected by the DMD device 8 towards a projection lens 7 following the path c-d-f-n.

The green and blue monochromatic components, which together form a cyan light beam, cross the prism 5 following the path a-e and reach surface of separation between the prism 5 and the prism 6.

Said surface of separation between the prism 5 and the prism 6 forms a second dichroic filter F2, which reflects the blue monochromatic component; while the green monochromatic component, shown in FIG. 1 with the dotted line, following the path e-g, illuminates a DMD device 9, the latter then reflects it towards the projection lens 7 following the path g-h-f-n.

Likewise the blue monochromatic component, shown with the hyphen-dot line, is reflected by the dichroic filter F2 and, following the path e-i-l, illuminates a DMD device 10, said blue monochromatic component is then reflected by the DMD device 10 towards the dichroic filters F1 and F2 and, following the path l-m-h-f-n, reaches the projection lens 7.

It has to be pointed out that in the known illumination system represented in FIG. 1, the three monochromatic light components, once they are reflected by the DMD devices 8, 9 and 10, to form a single light beam 11 such to be sent to the projection lens 7 and subsequently to the screen (not shown in FIG. 1), must coincide at point f.

The known illumination system shown in FIG. 1 has some drawbacks.

A first drawback is due to the fact that the dichroic filters F1 and F2 act both in the case of white light decomposition in the three monochromatic components, each of which is to be sent to the respective DMD devices 8, 9 and 10, and in the phase of recomposition of the light reflected by the DMD devices 8, 9 and 10 in a single light beam 11 to be sent to the projection lens 7.

Considering that, as shown in FIG. 1, the angles of incidence of the light beams on the dichroic filters F1 and F2 comprising the monochromatic components to be sent to the DMD devices 8, 9 and 10 are different from the angles of incidence on said dichroic filters F1 and F2 of the monochromatic components reflected by the DMD devices 8, 9 and 10, the treatment of the dichroic filters is difficult to be made and the chromatic yield is not optimal.

Moreover, as the active surfaces of the DMD devices 8, 9 and 10 must be completely illuminated, the white light beam 1 and the single light beams of the monochromatic components must have sufficiently wide sections, in order to take into consideration the various tolerances of the system; this implies a decrease of brightness of the entire illumination system and a dimension increase of the TIR prism 2 and of the prisms 4, 5 and 6, on which separating surfaces the dichroic filters F1 and F2 are realized.

Moreover a part of the monochromatic components light beams is anyway reflected also by the “switched off” pixel of any DMD device 8, 9 and 10 and, shedding in the prisms 4, 5 and 6 involves the other two DMD devices, causing a decrease in contrast.

Aim of the present invention is that of indicating an optical illumination system for videoprojectors which, by obviating the above mentioned drawbacks, ensures the manufacturing of videoprojectors of simple realization, increasing at the same time the performance.

To obtain such aims, it is the object of the present invention to provide an illumination system for videoprojectors having the features described in the annexed claims, which form an integral part of the description herein.

Further aims and advantages of the present invention will become apparent from the following detailed description and annexed drawings, which are supplied by way of non limiting example, wherein:

FIG. 1 shows a known illumination system

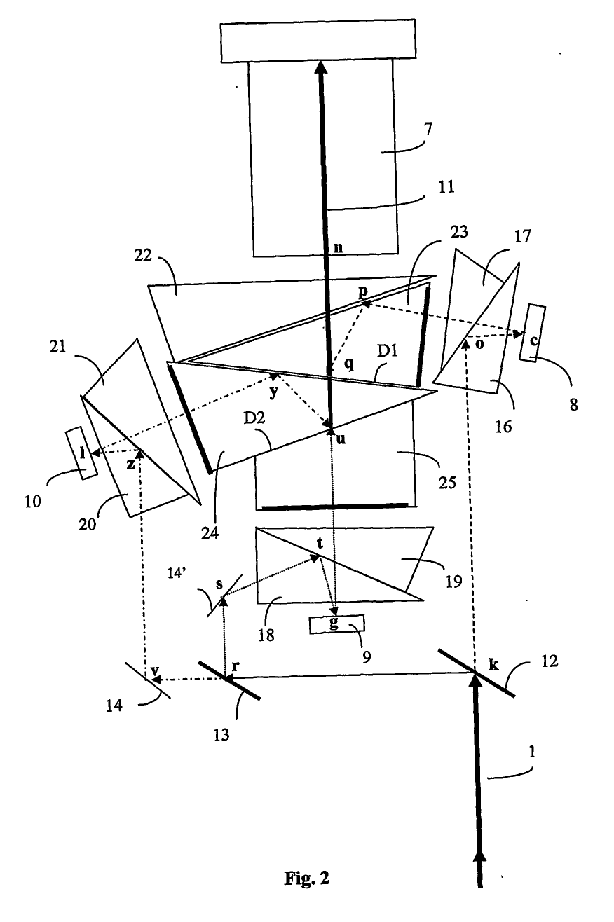

FIG. 2 shows a first embodiment of an illumination system according to the invention

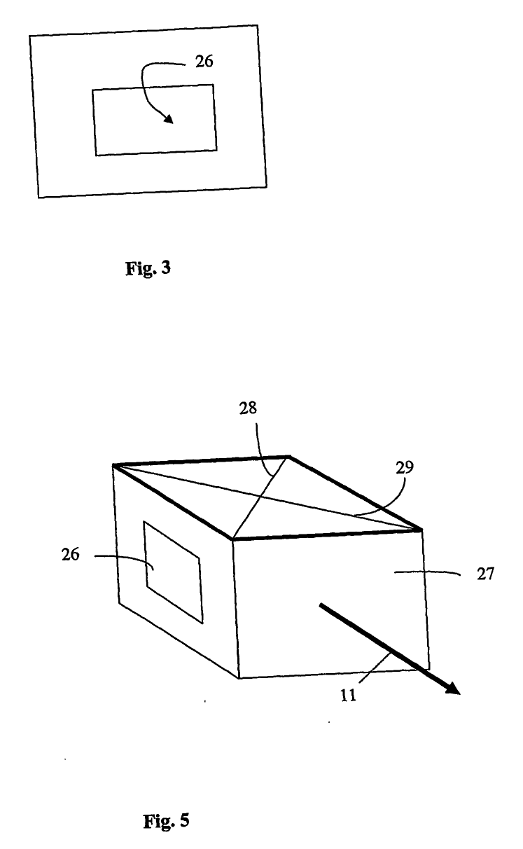

FIG. 3 shows a detail of the illumination system of FIG. 2

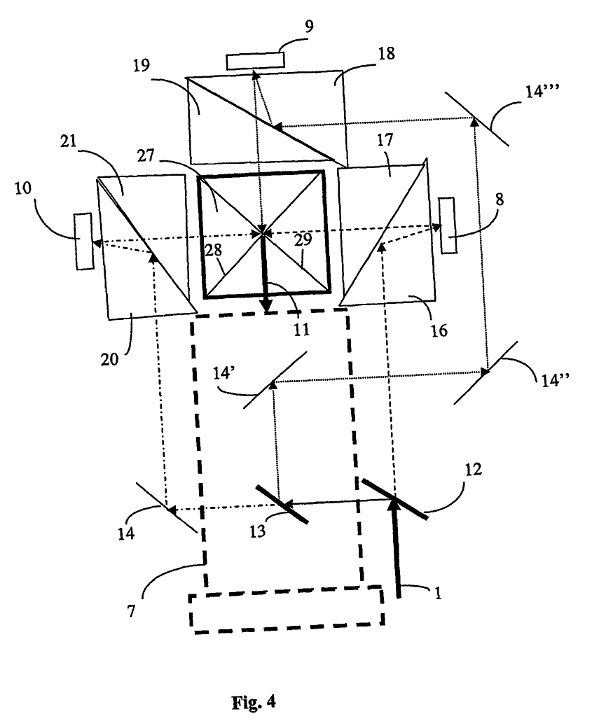

FIG. 4 shows a second embodiment of the illumination system according to the invention

FIG. 5 shows a detail of the illumination system used in connection with the embodiment of FIG. 4.

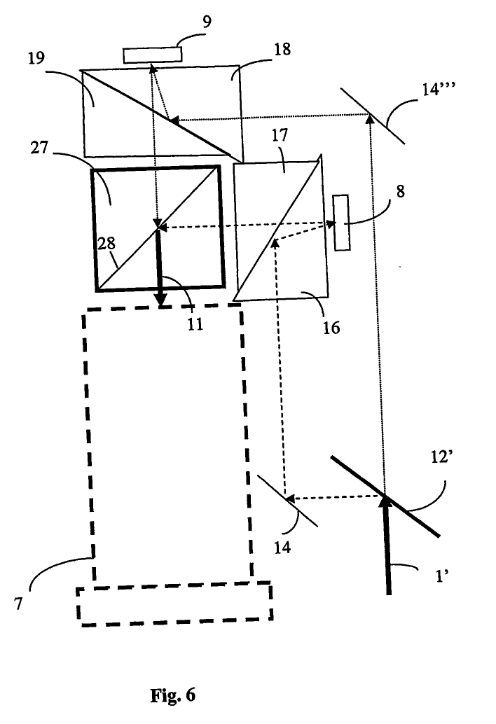

FIG. 6 shows a third embodiment of the illumination system according to the invention.

It is clear that the blocks indicating the same reference number in the various figures perform the same function.

FIG. 2 shows a first embodiment of an illumination system for a videoprojector according to the invention, in said system three DMD devices indicated with the reference numbers 8, 9 and 10 are used.

The light beam 1 is made up by a white light and it is sent to a dichroic filter 12, which reflects the green and blue monochromatic components towards a dichroic filter 13 and transmits the red monochromatic component.

Said red monochromatic component, following the path k-o-c-p-q-n indicated by the broken line and with the arrows, is sent by a prism of the type TIR 16, associated with a prism 17, to a DMD device 8 which reflects it towards a prism of the type TIR 23, associated to a prism 22.

The TIR prism 23 reflects the red monochromatic component towards the point q, which is on the surface of the prism 23 facing the TIR prism 24; this surface constitutes a dichotic filter D1 which reflects the red monochromatic component and transmits the green and blue ones, therefore the red monochromatic component is reflected from the point q towards n and then towards the projection lens 7

The light beam made up by the green and blue monochromatic components, after having been reflected by the dichroic filter 12, meets a dichroic filter 13 which transmits the blue monochromatic component and reflects the green monochromatic component towards the mirror 14′. The latter monochromatic component, following the path r-s-t-g represented by the dotted line and by the arrows, is reflected by the mirror 14′ towards the TIR prism 18, associated to the prism 19, and so to the DMD device 9.

The DMD device 9 reflects the green monochromatic component towards a prism 25; the surface of the TIR prism 24 facing the prism 25 constitutes a dichotic filter D2 which reflects the blue monochromatic component and transmits the green one, therefore the green monochromatic component can continue up to the point n and so to the projection lens 7 along the path g-u-q-n.

The blue monochromatic component, after having crossed the dichroic filter 13, is reflected by the mirror 14 and, following the path v-z-l-y-u-q-n represented by the hyphen-dot line and by the arrows, is sent by the TIR prism 20, associated to the prism 21, first towards the DMD device 10, and then towards the TIR prism 24, associated to the TIR prism 23, which reflects it towards the prism 25; since, as said, the dichroic filter D2 reflects the blue monochromatic component, the latter is reflected towards the point q and then towards the projection lens 7

Therefore in the point q the primary red, green and blue components are recomposed in a single light beam 11, which is sent to the projection lens 7.

In substance the decomposition of the light beam 1 in the primary components (red, blue and green) occurs using two dichroic filters 12 and 13; each of said primary monochromatic components is then sent to one of the three TIR prisms 16, 18, 20 each one of which is associated to a DMD device 8, 9, 10.

Instead the recomposition in a single light beam 11 of the primary monochromatic components coming from the DMD devices 8, 9, 10 occurs using:
a first dichroic filter D1, obtained on the surface of the TIR prism 23 facing the TIR prism 24, which reflects the red monochromatic component and transmits the green and blue monochromatic components;
a second dichroic filter, obtained on the surface of the TIR prism 24 facing the prism 25, which reflects the blue monochromatic component and transmits the green monochromatic component;
a first TIR prism 23 which provides for sending the red monochromatic component towards the point q, in such a way that it can be reflected by the dichroic filter D1 towards the projection lens 7;
a second TIR prism 24 which provides for reflecting the blue monochromatic component towards the dichroic filter D2, which provides for reflecting it towards the point q and, as a consequence, towards the projection lens 7.

The green monochromatic component, coming from the DMD device 9, is transmitted by the dichroic filters D1 and D2; therefore the green monochromatic component recomposes itself with the blue monochromatic component in the point u on the dichroic filter D2 and with the red monochromatic component in the point q present on the dichroic filter D1. In this way the recomposition of the monochromatic components in a single light beam 11 occurs.

As the dichroic filters 12 and 13 provide only for the decomposition of the white light in its primary monochromatic components (red, green and blue), the realization of the dichroic filters 12 and 13 is simpler and the orientation of the system is easier.

The same consideration is valid for the dichroic filters D1 and D2, which are only used in the recomposition phase of the monochromatic components of a light beam 11; this permits to optimize the dimension of the light beam of the monochromatic components and of the light beam 11, with the consequent increase of efficiency of the entire illumination system.

Normally in an illumination system for videoprojectors object of the present invention both the dichroic filters 12, 13, D1 and D2 and the TIR prisms 16, 18, 20, 23, 24 and the prisms 22 and 25 associated to the TIR prisms 23, 24 have reduced dimensions in respect to those used in the known illumination systems.

The surfaces of the TIR prisms 23, 24 and of the prism 25 respectively facing the DMD devices 8, 9 and 10 and shown in FIG. 2 with a thicker line, are each treated as shown in the front view in FIG. 3; each of said surfaces has an optical aperture 26, for example of rectangular shape, that only allows the reflected light of the pixel “switched on” of the respective DMD device 8, 9, 10 to pass through, while the light diffused by the pixel “switched off” is blocked by the remaining part of the surface.

Said optical aperture 26 is then adapted to control the dimensions of the light beam of any monochromatic component sent by each DMD device 8, 9, 10 to the projection lens 7; this way it is possible to avoid that the light diffused by the pixel “switched off” reaches the other two DMD devices, causing a decrease of contrast.

It is moreover possible to treat each optical aperture 26 in such a way that it is able to filter eventual spurious chromatic components present in the monochromatic components coming from the DMD devices 8, 9 and 10, making the colours reproduced more pure.

FIG. 4 shows a second embodiment of the invention.

The decomposition of the light beam 1 in the primary monochromatic components and the reflection of said primary monochromatic components towards the DMD devices 8, 9 and 10 occurs exactly as shown in FIG. 2, except that, to send the green monochromatic component towards the respective DMD device 9, in addition to the mirror 14′, also the mirrors 14′′ and 14′′′ are used.

The three monochromatic components reflected by the DMD 8, 9 and 10 are recomposed in a single light beam 11 through two dichroic filter, 28 and 29, arranged orthogonally among them and sloping by of about 45 degrees in respect to the direction of the monochromatic components incident on them.

Said dichroic filters 28 and 29 are commonly disposed on upright prisms and make up a device 27 having the known characteristic and shape of a parallelepiped.

FIG. 5 shows a three-dimensional view of the device 27; in use, it is placed in the system of illumination for videoprojectors according the present invention with three faces each placed parallel to a DMD device 8, 9 and 10; each of these three faces has the same configuration as the one shown in FIG. 3, therefore the considerations previously made are still valid.

With reference to FIG. 4, both dichroic filters 28 and 29 transmit the green monochromatic component, while the dichroic filter 28 reflects the red monochromatic component and transmits the blue one and the dichroic filter 29 reflects the blue monochromatic component and transmits the red monochromatic component. In substance the dichroic filters 28 and 29 recompose in a single light beam 11 the three monochromatic components coming from the DMD devices 8, 9 and 10.

The light beam 11 is then sent to the projection lens 7; the latter is shown in FIG. 4 with a broken line to point out that the projection lens 7 must be positioned on a different plane with respect to those on which are positioned the dichroic filters 12 and 13 and the reflecting surfaces 14 and 14′, in order to avoid possible mechanical and optical interferences.

In the embodiment shown as example in FIG. 4, the decomposition of the light beam 1 in the primary monochromatic components, each to be sent to the respective DMD device 8, 9 and 10, occurs using the dichroic filters 12 and 13; instead, the recomposition of the monochromatic components coming from said DMD devices 8, 9 and 10 in a single light beam 11 occurs using the dichroic filters 28 and 29.

It is clear that many changes can be made to the illumination system according to the present invention, without exiting from the novelty principles of the inventive idea.

For example. FIG. 6 shows an illumination system for videoprojectors according to the present invention which uses two DMD devices 8 and 9.

In this case the light beam 1′ is constituted in sequence by a yellow light beam, formed by the red and green monochromatic component, and by a magenta light beam, formed by the red and blue monochromatic components.

Said magenta and yellow light beams are obtained by sending a white light beam to a colour wheel, not shown in FIG. 6, which in this case it is divided into two sectors; the first of said sectors is made up of a dichroic filter which reflects the blue monochromatic component and transmits the yellow light beam 1′, the second has a dichroic filter which reflects the green monochromatic component and transmits the magenta light beam 1′.

The dichroic filter 12′ reflects the red monochromatic component of the light beam 1′, which in sequence is yellow or magenta; said red monochromatic component is then deviated by the reflecting surface 14 towards the TIR prism 16 and by this towards the DMD device 8.

The dichroic filter 12, moreover, transmits the green monochromatic component of the yellow light beam 1′ and the blue monochromatic component of the magenta light beam 1′; such green and blue monochromatic components, since they are part of light beams sent in sequence to the dichroic filter 12′, they are also deviated in sequence by the reflecting surface 14′′ towards the TIR prism 18, which reflects them on the DMD device 9.

The device 27 has only two active faces, those turned respectively to the DMD devices 8 and 9, each of which contains the optical aperture 26 already described; moreover only the dichroic filter 28 is present in the device 27, which reflects the red monochromatic component towards the projection lens 7 and transmits the green and blue monochromatic component after these have been reflected in sequence by the DMD device 9.

Therefore, in the embodiment shown as example in FIG. 6, the dichroic filter 12′ decompose the light beam 1′ in one of the two monochromatic components of which it is made up, while the dichroic filter 28 allows the primary monochromatic components to recompose in order to form a light beam 11.

It is clear that many other changes and applications are easily produced and used by the person skilled in the art on illumination systems described, so as it is clear that in the practical use of the invention the shapes and sizes of the components can be different and the same can be substituted by equivalent technical elements.

1. Illumination system for videoprojectors comprising:
a light beam;
first means adapted to decompose said light beam into a plurality of monochromatic components;
a plurality of DMD devices each of which reflects one of said monochromatic components;
a plurality of devices adapted to send said monochromatic components towards said plurality of DMD devices;
second means separate from said first means adapted to recompose said monochromatic components coming from said DMD devices into a light beam to be sent to a projection lens, said second means comprising dichroic filters and TIR prisms.

2. Illumination system for videoprojectors according to claim 1, wherein said plurality of devices comprises TIR prisms.

3. Illumination system for videoprojectors according to claim 1, wherein each DMD device is associated with a TIR prism.

4. Illumination system for videoprojectors according to claim 1, wherein the videoprojector uses three DMD devices.

5. Illumination system for videoprojectors according to claim 1, wherein the videoprojector uses two DMD devices.

6. Illumination system for videoprojectors according to claim 1, wherein said first means adapted to decompose said light beam into a plurality of monochromatic components comprises dichroic filters.

7. Illumination system for videoprojectors according to claim 1, wherein each DMD device is associated with an element having an optical aperture that controls the dimensions of the light beam of any monochromatic component sent by each DMD device to the projection lens.

8. Illumination system for videoprojectors according to claim 7, wherein said element comprises a right prism.

9. Illumination system for videoprojectors according to claim 7, wherein said element comprises a TIR prism.

10. Illumination system for videoprojectors according to claim 8, wherein said element comprises a device with a shape of a parallelepiped.

11. Illumination system for videoprojectors according to claim 10, characterized in that said device is adapted to include dichroic filters.

12. Illumination system for videoprojectors according to claim 7, wherein said optical aperture can be treated in such a way that it filters spurious chromatic components present in the monochromatic components reflected by said DMD devices.

13. Illumination system for videoprojectors according to claim 7, wherein said optical aperture is rectangular in shape.
